(19) United States
(12) Patent Application Publication
(10) Pub. No.: US 2012/0101951 A1
(43) Pub. Date: Apr. 26, 2012

(54) Method and System for Secure Financial Transactions Using Mobile Communications Devices

(76) Inventors: Michael Li, South Riding, VA (US); Yuri Shakula, Reston, VA (US); Martin Rodriguez, Bristow, VA (US)

(21) Appl. No.: 13/172,170

(22) Filed: Jun. 29, 2011

Related U.S. Application Data
(60) Provisional application No. 61/406,097, filed on Oct. 22, 2010.

(51) Int. Cl. G06Q 20/00

(52) U.S. Cl. 705/71

(57) ABSTRACT

The present invention employs public key infrastructure to electronically sign and encrypt important personal information on a mobile communications device (MCD), without disclosing private, personal information to the transaction counterparts and middleman, thus preserving highly elevated and enhanced security and fraud protection. In one embodiment, the present invention can use a mobile device identifier, such as a cell phone number or email address, for example, as an index/reference during the entire transaction, so that only the account holder and the account issuer know the underlying account number and other private information.

### CROSS-REFERENCE TO RELATED APPLICATIONS

This application claims benefit and priority of provisional application Ser. No. 61/406,097, filed Oct. 22, 2010, which is incorporated by reference in its entirety herein.

### FIELD OF THE INVENTION

The present invention pertains to secure mobile communications, and more particularly, to a method and system for providing secure financial transactions using mobile communications devices.

### BACKGROUND OF THE INVENTION

Today, important personal financial information, such as social security numbers, bank account, credit card and debit card numbers exist in an open format. Identify theft can occur because such numbers are not secure and can be compromised in the middle of a transaction.

At the same time, banks are currently being displaced from the mobile payments space. Services such as Obopay™, for example, permit users to transmit bank account funds or funds that they have pre-paid into an account using their wireless device and without using a bank. We are witnessing a growth in the usage of mobile devices, most of which have processing and networking capabilities and the potential to deliver a new class of rich financial transactions. This empowers new providers of services such as mobile money transfers, domestic remittances, mobile bill payments, etc. Most of the current solutions appear to rely on pre-established partnerships with phone carriers and sometimes involve banks. However, such offerings are generally for a limited number of customers and have limited reach and very limited security features.

### SUMMARY OF THE PRESENT INVENTION

The present invention provides, in part, a solid and proven infrastructure built on top of strong encryption algorithms based on public key infrastructure (PKI) running in Mobile Security Module (MSM) as the model for encryption and digital signature for authentication and non-repudiation of messages.

The present invention further provides a secure foundation for building financial tools, such as credit card applications and debit card applications, and for conducting financial transactions on mobile communications devices. In one embodiment of the present invention, it uses public key infrastructure to electronically sign and encrypt important personal information on a mobile communications device (MCD). It also enables legal, financial account holders to perform payment, withdraw/deposit, and remittance transactions without disclosing private, personal information to the transaction counterparts and middleman, thus preserving highly elevated and enhanced security and fraud protection. For example, the present invention can use a mobile device identifier (e.g., a cell phone number or email address) as an index/reference during the entire transaction, so that only the account holder (e.g., person/institution) and the account issuer (e.g., bank/institution) know the real account number and/or other private information such as the transaction amount, for example.

The present invention can be employed by members of the financial industry to build credit card applications, debit card applications and mobile banking and financial transactions for the mass market.

Typical information exchanged in a transaction includes:

(1) the payment amount;

(2) the payer's mobile identifier (MID) or phone number;

(3) the payer's bank identifier code (BIC) or routing number;

(4) the payer's bank account number or credit card number;

(5) the payee's mobile identifier (MID) or phone number;

(6) the payee's bank identifier code (BIC) or routing number; and

(7) the instruction to deliver the payment to the payee's bank account or to pick up cash by the payee at a location designated by the payer.

According to the present invention, the payer's confidential account data (e.g. account number, transaction amount) is encrypted at the mobile communications device using the public key certificate of the payer's bank. As such, only the payer's bank can decrypt the account data by using its private key. In other words, only the payer and the payer's bank have access to the confidential account data of payer. Using the Mobile Security Module in accordance with the present invention, the entire content of the message is digitally signed by the private key of the payer to maintain the integrity, security, and confidentiality of the information. The whole message can then be verified and decrypted by the payer's bank or institution using the payer's public key and the payer's bank's private key respectively. Although a financial institution can verify the transaction message locally by using the payer's public key certificate, the financial institution would still need to check a certificate revocation list (CRL), which is maintained by an identity service provider, to determine whether the payer's identity certificate is still valid (e.g., not expired).

Non-repudiation service can also be used in accordance with the present invention for mobile transactions to protect against transaction disagreements by verifying digital signatures which are stored by the identity service provider. To enable the non-repudiation service, the identity service provider stores the digital signature of the parties involved in the transaction, as well as a transaction reference number, date of the transaction, time of the transaction, and location of the parties to the transaction. The present invention can also provide for the rejection of a financial transaction based on a pre-defined transaction policy. For example, such a policy may restrict or deny the transaction based upon the location of the payer or the payee or other qualifications. With regard to location, a Global Positioning System (OPS) can be used to track the latitude and longitude coordinates of the payer or the payee. If the GPS location of the payer or payee is beyond a pre-defined range of coordinates, the transaction may be rejected.

### BRIEF DESCRIPTION OF THE DRAWINGS

FIGS. 1a through 1f are schematic diagrams illustrating a sequence of steps a payer takes to obtain an identity certificate in accordance with one embodiment of the present invention.

FIGS. 2 through 4 are schematic diagrams illustrating an “e-bank” communications process according to an embodiment of the present invention.

FIGS. 5 through 9 are schematic diagrams illustrating an “e-check” transaction process according to an embodiment of the present invention.

FIG. 10 is a schematic diagram illustrating one embodiment of the underlying technology used by the embodiments of the present invention.

### DETAILED DESCRIPTION OF THE INVENTION ASPECTS

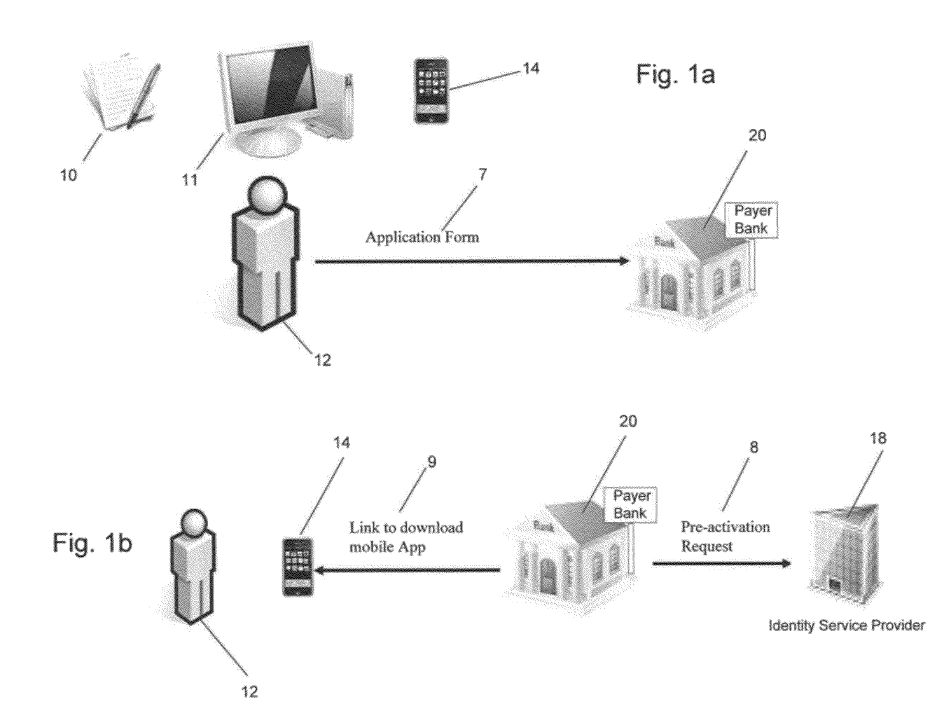

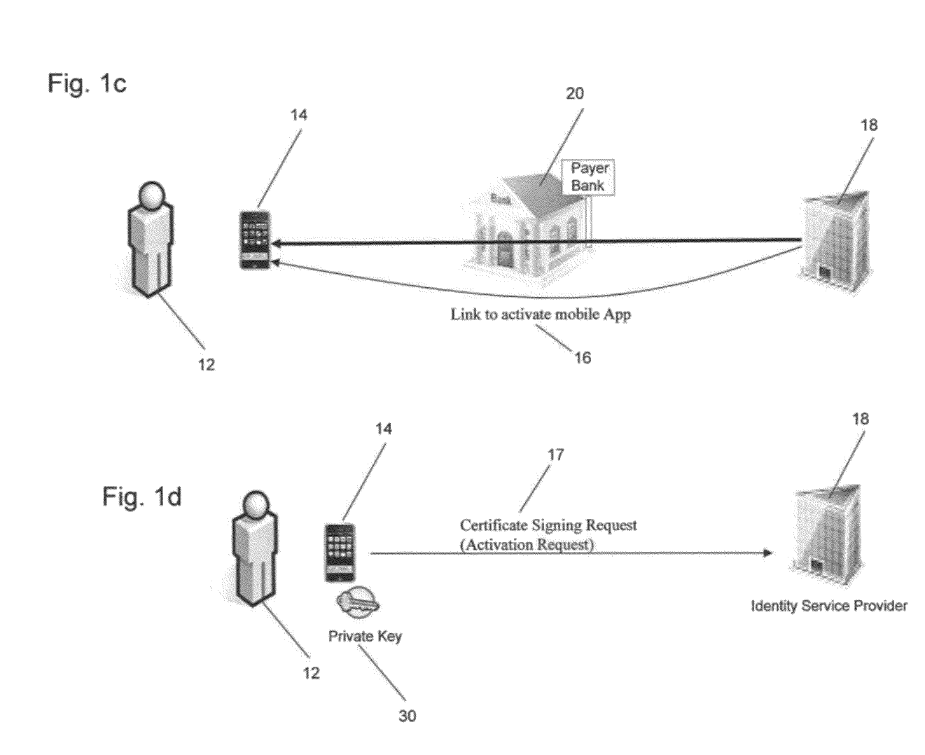

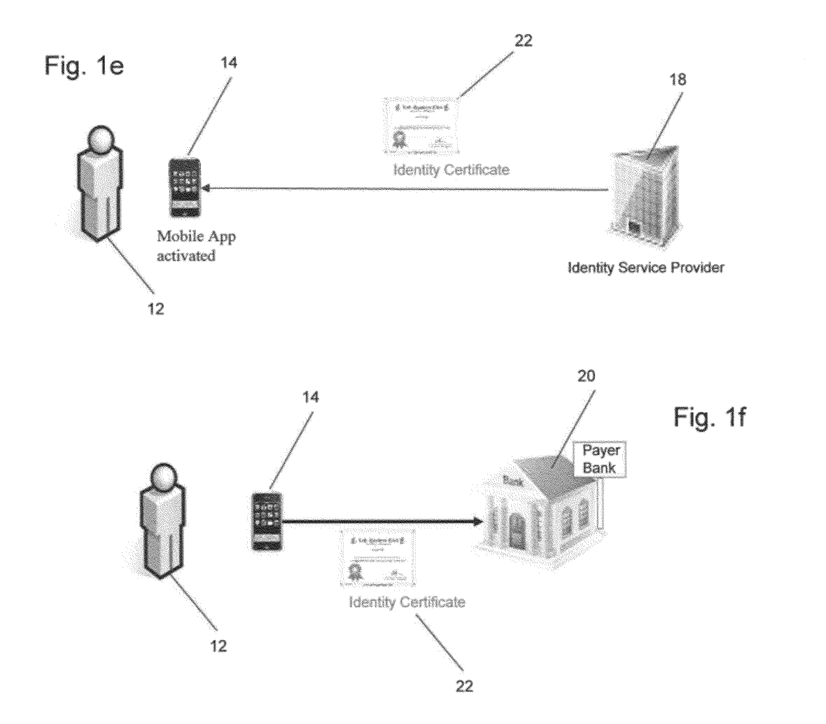

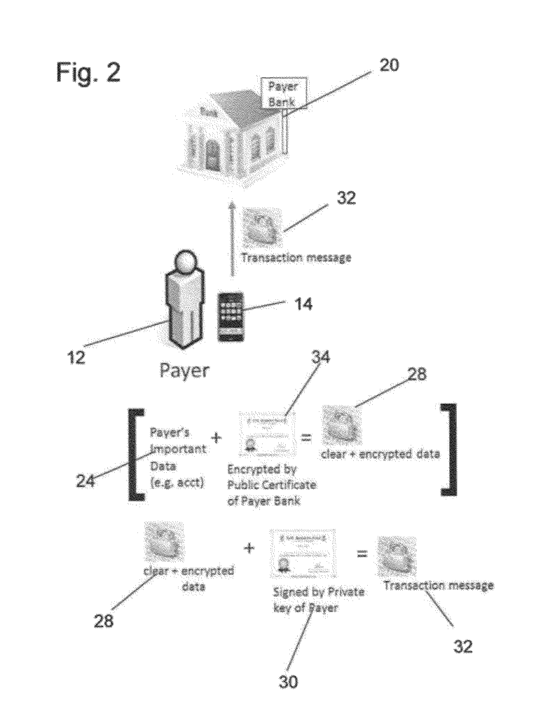

Features and functions of the present invention can be better understood with reference to FIGS. 1 through 10.

FIGS. 1a through 1f show the process a payer (or payee) undergoes to obtain an identity certificate. An identity certificate, also known as a PKI certificate, public key certificate or digital certificate, is an electronic document which uses a digital signature to bind a public key with an identity, which can be information such as the name of a person or an organization, their address, or other identifying information, for example. The certificate can be used to verify that a public key belongs to an individual. As shown in FIG. 1a, a payer 12 fills in a paper form 10 or online form 11 or directly uses a mobile device 14 to apply for a bank application (such as a credit card or debit card, for example) or a mobile token. The mobile token permits secure storage of one or more identity certificates on a mobile communications device. The payer 12 sends the completed application form 7 to his bank 20 by using, for example, mobile communications device (MCD) 14. The bank application and/or mobile token contain identity certificates issued by an identity service provider 18 (see FIG. 1b) for secure personal authentication and financial transactions.

As shown in FIG. 1b, after receiving the application form, the payer's bank (also referred to as a financial institution where the payer has an account) 20 sends a pre activation request 8 for the payer 12 to the identity service provider 18. The payer's bank 20 also sends a link 9 to payer's MCD 14 to download a mobile application (mobile app) which corresponds to either the bank application or the mobile token. Typically, the mobile app can be found in an app store such as, for example, Apple App Store™ or Google Apps Marketplace™. In accordance with one embodiment of the present invention, if the mobile app is already downloaded, this step is unnecessary.

As shown in FIGS. 1c through 1e, before the mobile app can be used, the payer's MCD 14 will receive a link 16 to activate the mobile app. This link 16 can come directly from the identity service provider 18, or through payer's bank 20. The payer 12 then follows the link on his MCD 14 to generate a key pair, public key and private key 30, on the device. The payer 12 then sends a certificate signing request (CSR) 17 to the identity service provider 18. As shown in FIG. 1e, the identity service provider 18 receives the CSR and returns an identity certificate 22 to the payer's MCD 14, thus activating the mobile app. As shown in FIG. 1f, the payer 12 can further use the MCD 14 to register his identity certificate 22 with his bank 20 depending on his bank's policy. The payee can follow the same process to receive an identity certificate.

Using the identity certificate 22, the payer 12 can operate the system of the present invention to make payments in different ways. FIGS. 2 through 4 illustrate an “e-hank” operation. As shown in FIG. 2, when the payer 12 desires to make a payment transaction, he or she encrypts important account information (e.g., account number) 24 using the public key certificate 34 of his (payer) bank, thereby providing a clear+encrypted data message 28. This message 28 is digitally signed using the private key 30 of the payer to form a final transaction message 32 for delivery. All of these processes are performed by the user using his or her MCD 14, which can then be used to transmit the transaction message 32 to the payer bank 20.

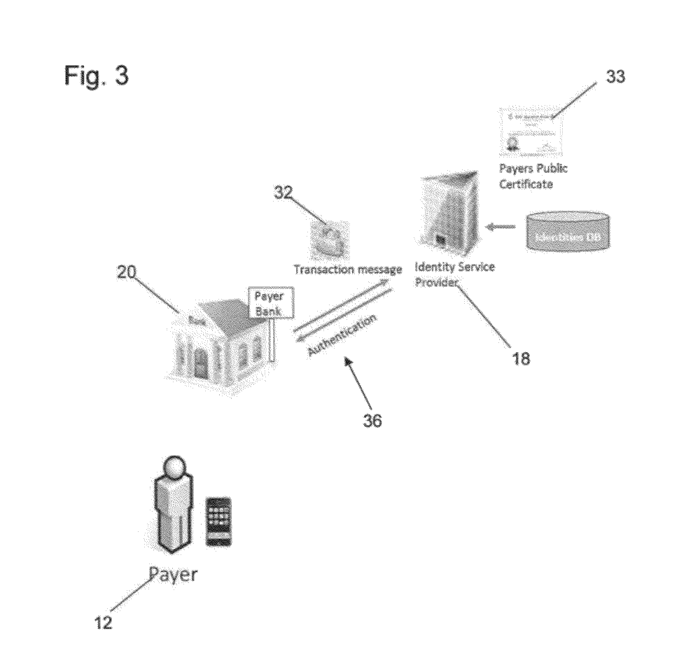

As shown in FIG. 3, the message 32 is next sent by the payer bank 20 to the identity service provider 18, which can then authenticate the identity of the payer 12 using the payer's public key certificate 33. The authentication communications are represented by arrows 36. The issuing certification authority (here the identity service provider) vouches for the validity of the identity by accessing the payer's public key to verify the identity certificate. If the signature cannot be verified, the certificate is presumed to be untrustworthy. Payer's bank can also verify the transaction message locally, but the certificate itself must be verified as still valid by the identity service provider. Therefore, if the payer's bank verifies the transaction message locally, it would still need to check the certificate revocation list which is maintained by the identity service provider.

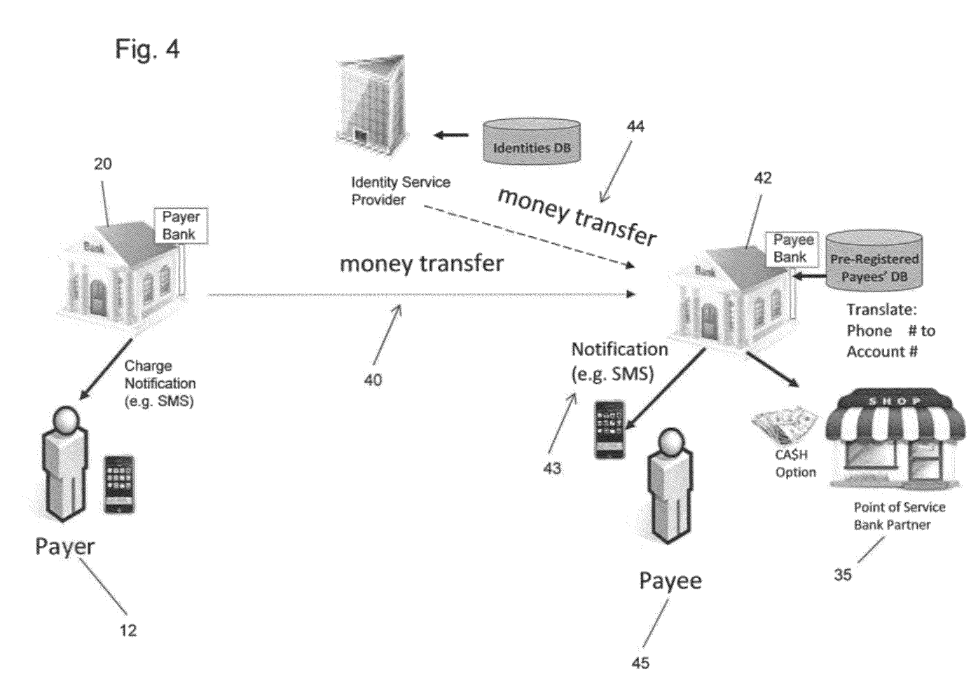

Referring to FIG. 4, if the identity of payer 12 is verified, then payer bank 20 sends payment 40 from payer's account to payee bank (also referred to as a financial institution where the payee has an account) 42. Payment can alternatively go through the identity service provider 18 to make a settlement for the benefit of payee 45, as indicated by arrow 44. It will be appreciated that, in such a case, the identity service provider 18 may first need to have a suitable service agreement with the payer bank 20 and the payee bank 42.

After receiving a payment, payee bank 42 will credit the amount of the transaction to payee's account based on payee's pre-registered mobile identifier (usually a telephone number) and send a deposit notification 43 to payer 45. If the payee does not have a bank account or the payee chooses to receive a cash payment, the payee can receive cash at a point of service location (also referred to as bank partner) 35 designated by the payer 12, where the bank partner (e.g., store/financial institution) managing the point of service location 35 will have a partnership with the payer's bank 20 or the identity service provider 18. Once the transaction is completed, the payer's bank 20 will notify the payer 12. Notifications can be sent by short message service (SMS), for example.

It will be appreciated that the financial institutions, partners and identity service provider maintain sufficient devices and communications technology in order to operate in accordance with the present invention as described herein. For example, financial institutions, partners and identity service provider maintain computing capability in the form of one or more computers each having a processor and memory, wherein the memory stores programming for carrying out the functions described. Further, the one or more computers can access and can be accessed by one or more electronic networks for purposes of communication with one another, wherein the one or more networks can be public (e.g., the Internet) or private. It will further be appreciated that each MCD 14 contains at least one processor and memory unit, Wherein the memory stores programming (e.g., mobile applications) for carrying out the functions described herein.

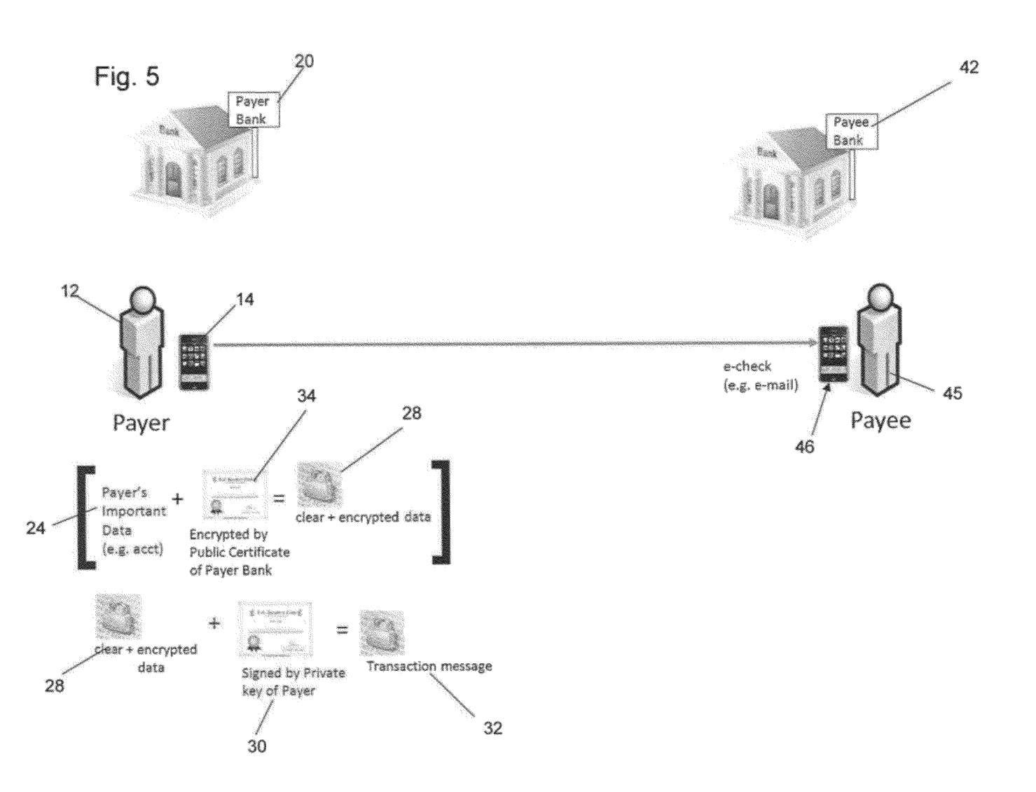

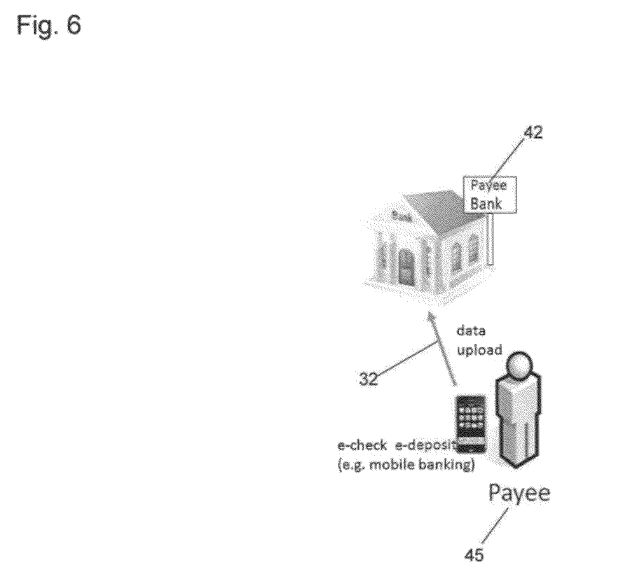

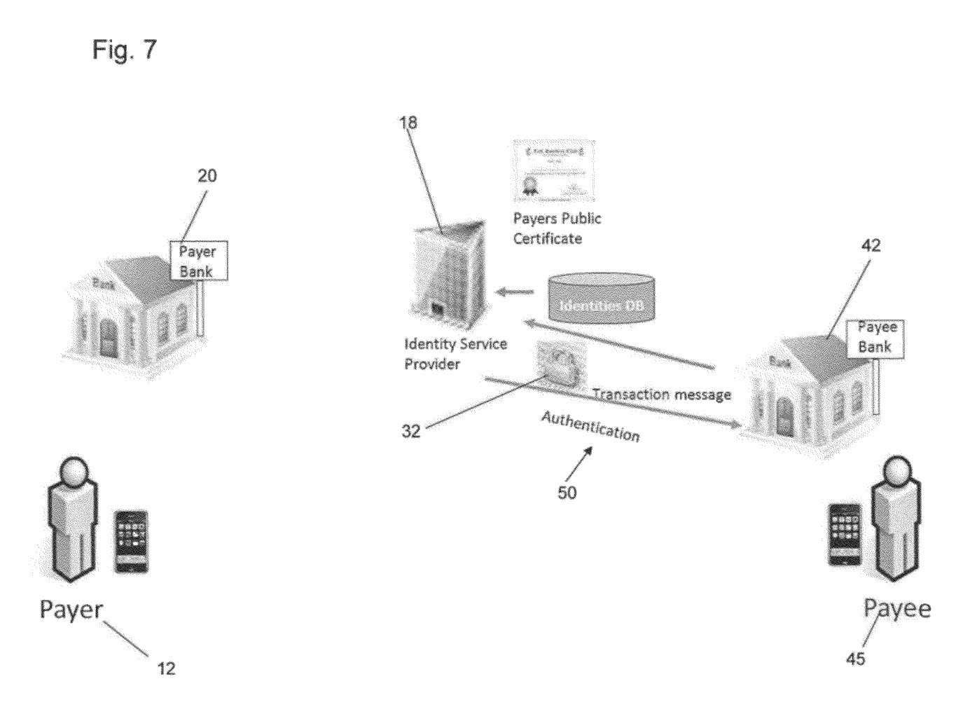

FIGS. 5 through 9 illustrate an alternative “e-check” route for payment processing. As shown in FIG. 5, and assuming the certificate request and receipt associated with FIGS. 1a through 1f have occurred already, when payer 12 makes a payment, the important information 24 (e.g., account number, transaction amount) is encrypted using the public key certificate of the payer's bank 34 to form the clear+encrypted data message 28, and this message is digitally signed by the private key 30 of the payer. The payer uses the payer's MCD 14 to send the complete transaction message 32 directly to the MCD 46 of payee 45. In accordance with one embodiment of the present invention, the communication can be sent by electronic mail. As shown in FIG. 6, the payee 45 e-deposits (i.e., uploads) the transaction message 32 to his bank 42. As shown in FIG. 7, the payee's bank 42 will then ask the identity service provider 18 to authenticate the identity of payer 12 and payee 45, which process is indicated by arrows 50. Payee's hank can also verify the payer and payee's identity locally, but payee's bank would still need to check the certificate revocation list which is maintained by the identity service provider 18.

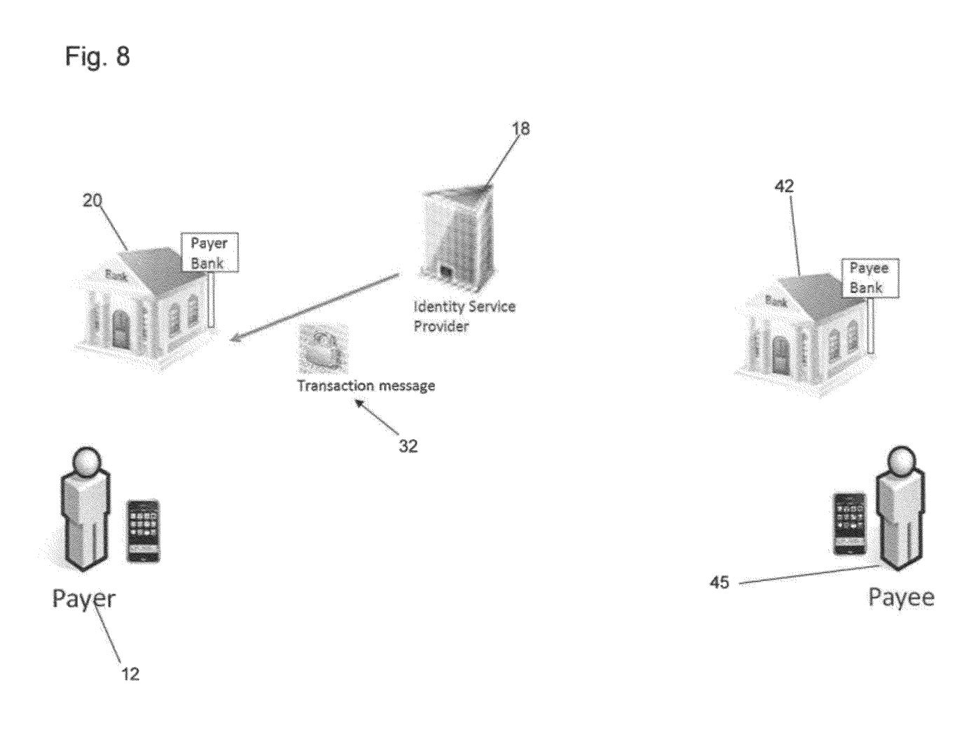

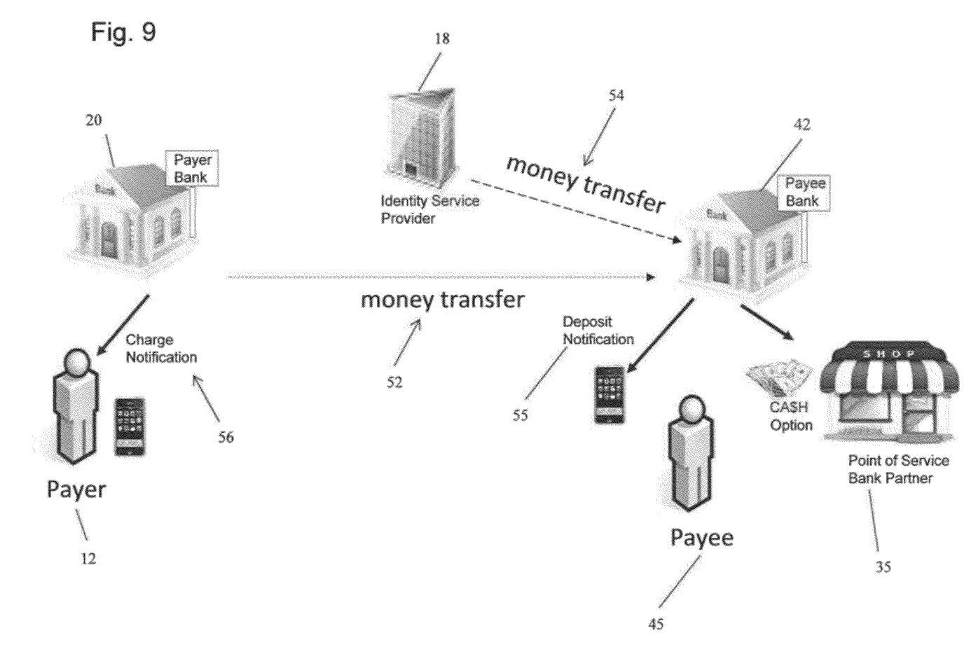

As shown in FIG. 8, if the identity of payer 12 is authenticated, the identity service provider 18 will send the transaction message 32 to payer's bank 20. After receiving the transaction message 32, the payer bank can use its private key to decrypt the transaction message. As shown in FIG. 9, the payer bank 20 sends payment 52 from payer's account to payee bank 42. The payment 54 can alternatively go through the identity service provider 18 to make a settlement. However, in such a case, it will be appreciated that the identity service provider 18 may first need to have a suitable service agreement with the payer bank 20 and the payee hank 42.

After receiving a payment, payee bank 42 will credit the amount of the transaction to payee's account based on payee's pre-registered mobile identifier (usually a telephone number) or payee bank 42 will credit the amount of the transaction to payee's account while payee is logged into his/her account in a session of mobile banking. Payee bank 42 will send a deposit notification 55 to payee 45, and payer bank 20 will send a charge notification 56 to payer 12. If the payee 45 does not have a bank account or the payee chooses to receive cash, the payee can receive cash at a point of service location 35 designated by the payee 45, where the bank partner (e.g., store/financial institution) managing the point of service location 35 has a partnership with the payee bank 42 and where the transaction message is uploaded or with the identity service provider 18.

In accordance with one embodiment of the present invention, a single identity service provider 18 can provide identity certificate service to multiple financial institutions. Each financial institution has multiple users, such as payers and payees. Each user obtains an identity certificate, issued by the identity service provider, through their respective financial institution. The identity certificate is received by the user's mobile communication device. The identity service provider can then authenticate a user's identity for multiple financial institutions.

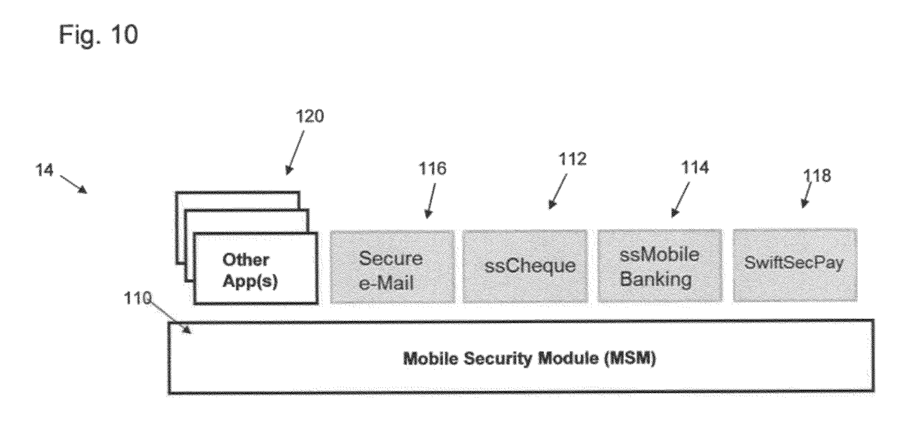

As shown in FIG. 10, the underlying technology of the present invention can include a Mobile Security Module (MSM) 110 stored on the MCD 14, comprising standard PKI software customized to work with digital certificates issued from an authority such as Society for Worldwide Interbank Financial Telecommunications (S.W.I.F.T.). One aspect of the present invention is designed to run on a smartphone and/or above MCD 14 such as, for example, an iPhone™, Android™, iPad™, Android™ tablet, and/or any other similar such device. The underlying technology can further incorporate OCSP (Online Certificate Status Protocol) client capability, in accordance with one embodiment of the present invention. The MCD 14 can further employ software for providing services such as e-check (e.g., Swift Secure Check) 112, mobile banking (e.g., Swift Secure Mobile Banking) 114, Secure e-Mail 116 and/or Swift Secure Pay 118, which provides for instant and secure online payments, and other bank products and applications 120.

In one embodiment of the present invention, non-repudiation service can also be provided for mobile transactions to protect against transaction disagreements by verifying digital signatures which are stored by the identity service provider. To enable the non repudiation service, the identity service provider stores the digital signature of the parties involved in the transaction, or at least the payer involved in the transaction, as well as a transaction reference number, date of the transaction, time of the transaction, and location of the parties to the transaction. The identity service provider can also store a digital signature of the financial institution where the payer has an account for verification in order to provide the non-repudiation service. Further, the identity service provider can verify the digital signature of the payer in order to provide the non-repudiation service.

The present invention can also provide for the rejection of a financial transaction based on a pre-defined transaction policy. For example, such a policy may restrict or deny the transaction based upon the location of the payer or the payee or other qualifications. With regard to location, a Global Positioning System (GPS) can be used to track the latitude and longitude coordinates of the payer or the payee. If the GPS location of the payer or payee is beyond a predefined range of coordinates, the transaction may be rejected.

The present invention can operate equally well in many operating environments, such as Apple iOS™ and Google Android™, for example. It will be appreciated that the present invention can be employed for a variety of applications and transaction environments, including online shopping, online recurring bill payment, traditional consumer transactions (e.g., groceries, fuel, dining, traveler's expenses, online banking, cash withdrawals, wiring funds, mobile phone payments), ticket payments for entrance to an event or for travel fare, E-Z pass, and other similar transactions. The present invention can further be adapted for use in protecting other information that should be kept private, including a digital social security number (SSN), digital legal documents (e.g., driver's license, birth certificate, certificate of residence or nationality), digital passports or VISAs, digital votes. The present invention can further be adapted for digital access control to premises or e-health records, as well as in-car computing.

The invention may be embodied in other specific forms without departing from the spirit or essential characteristics thereof. The present embodiments are therefore to be considered in all respects as illustrative and not restrictive, the scope of the invention being indicated by the claims of the application rather than by the forgoing description, and all changes which come within the meaning and range of equivalency of the claims are therefore intended to be embraced therein.

1. A method of performing secure financial transactions from a mobile communications device, the method comprising:
receiving from a mobile communications device a request for an identity certificate associated with a payer;
sending the identity certificate associated with the payer to the mobile communications device;
receiving from a financial institution in which the payer has an account a transaction message comprised of digitally signed and encrypted transaction data of the payer;
authenticating the identification of the payer using a public key certificate of the payer; and
upon authenticating the identification of the payer, notifying the financial institution in which the payer has an account that the identification of the payer has been authenticated such that the encrypted transaction data can be decrypted by the financial institution and a payment approved subject to the payer's account having sufficient funds.

2. The method of claim 1, including the further step of first receiving a pre-activation request for the identity certificate associated with the payer from the financial institution in which the payer has an account.

3. The method of claim 1, including the further step of sending a link to the mobile communications device to activate a mobile application.

4. The method of claim 1, including the further step of receiving a request to check the certificate revocation list for the identity certificate associated with the payer in order to verify the validity of the identity certificate associated with the payer.

5. The method of claim 1, wherein the transaction data of the payer is encrypted using a public key certificate of the financial institution in which the payer has an account.

6. The method of claim 1, wherein the encrypted transaction data of the payer is digitally signed using a private key of the payer.

7. The method of claim 1, wherein the payment is approved for a cash payment to a payee at a location designated by the payer, wherein the location has a partnership with the financial institution where the payer has an account.

8. The method of claim 1, wherein the payment is approved for a cash payment to a payee at a location designated by the payer, wherein the location has a partnership with the identity service provider.

9. The method of claim 1, wherein the payment is approved for payment to a payee account at a financial institution associated with a payee based on a pre-registered mobile identifier associated with the payee.

10. The method of claim 1, wherein the transaction message received from the financial institution where the payer has an account is first received from the mobile communications device by the financial institution where the payer has an account.

11. The method of claim 1, including the further step of enabling non-repudiation service to protect against transaction disagreements, comprising:
storing a digital signature of the financial institution where the payer has an account;
storing a digital signature of the payer;
storing a transaction reference number, a date of the transaction, and a time of the transaction;
storing location information associated with the payer,
verifying the digital signature of the financial institution where the payer has an account; and
verifying the digital signature of the payer.

12. The method of claim 11, including the step of storing a transaction policy having criteria for rejecting a proposed transaction associated with the transaction message, wherein the criteria is based upon the location of the payer.

13. A method of performing secure financial transactions from a mobile communications device, the method comprising:
receiving from a first mobile communications device a request for an identity certificate associated with a payer;
sending the identity certificate associated with the payer to the first mobile communications device;
receiving from a second mobile communications device a request for an identity certificate associated with a payee;
sending the identity certificate associated with the payee to the second mobile communications device;
receiving from a financial institution associated with the payee a transaction message comprised of digitally signed and encrypted transaction data of the payer;
authenticating the identification of the payer using a public key certificate of the payer;
authenticating the identification of the payee using a public key certificate of the payee; and
upon authenticating the identification of the payer and the payee, transmitting the transaction message to a financial institution where the payer has an account such that the transaction message can be decrypted by the financial institution where the payer has an account and a payment approved subject to the payer's account having sufficient funds.

14. The method of claim 13, including the further step of first receiving a pre-activation request for the identity certificate associated with the payer from the financial institution where the payer has an account.

15. The method of claim 13, including the further step of sending a link to the first mobile communications device to activate a mobile application.

16. The method of claim 13, including the further step of receiving a request to check a certificate revocation list for the identity certificates associated with the payer and the payee.

17. The method of claim 13, wherein the transaction data of the payer is encrypted using the public key certificate of the financial institution in which the payer has an account.

18. The method of claim 13, wherein the encrypted transaction data of the payer is digitally signed using a private key of the payer.

19. The method of claim 13, wherein the payment is approved for a cash payment to a payee at a location designated by the payee, wherein the location has a partnership with the financial institution associated with the payee.

20. The method of claim 13, wherein the payment is approved for a cash payment to a payee at a location designated by the payee, wherein the location has a partnership with the identity service provider.

21. The method of claim 13, wherein the payment is approved for payment to a payee account at a financial institution associated with the payee based on a pre-registered mobile identifier associated with the payee.

22. The method of claim 13, wherein the transaction message received from the financial institution associated with the payee is first received from the second mobile communications device.

23. The method of claim 22, wherein the transaction message received from the second mobile communications device is first received from the first mobile communications device.

24. The method of claim 13, further including the step of enabling non-repudiation service to protect against transaction disagreements, comprising:
storing a digital signature of the financial institution associated with the payee;
storing a digital signature of the payer;
storing a digital signature of the payee;
storing a transaction reference number, a date of the transaction, and a time of the transaction;
storing location information associated with the payer;
storing location information associated with the payee;
verifying the digital signature of the financial institution associated with the payee;
verifying the digital signature of the payer; and
verifying the digital signature of the payee.

25. The method of claim 24, including the step of storing a transaction policy having criteria for rejecting a proposed transaction associated with the transaction message, wherein the criteria is based upon the location of the payer or payee.

26. A method of performing secure financial transactions from a mobile communications device, the method comprising:
receiving a transaction message comprised of digitally signed and encrypted transaction data of a payer;
requesting authentication of the identification of the payer;
receiving authentication of the identification of the payer;
decrypting the transaction message; and
sending a payment.

27. The method of claim 26, wherein the step of requesting authentication of the identification of the payer includes requesting authentication of the identification of the payer from a financial institution where the payer has an account; and wherein the step of receiving authentication of the identification of the payer includes receiving authentication of the identification of the payer from the financial institution.

28. The method of claim 26, wherein the step of requesting authentication of the identification of the payer includes requesting authentication of the identification of the payer from an identity service provider; and wherein the step of receiving authentication of the identification of the payer includes receiving authentication of the identification of the payer from the identity service provider.

29. A method of performing secure financial transactions from a mobile communications device, the method comprising:
receiving a transaction message comprised of digitally signed and encrypted transaction data of a payer;
requesting authentication of the identification of the payer;
receiving authentication of the identification of the payer; and
receiving a payment.

30. The method of claim 29, wherein the step of requesting authentication of the identification of the payer includes requesting authentication of the identification of the payer from a financial institution where the payer has an account; and wherein the step of receiving authentication of the identification of the payer includes receiving authentication of the identification of the payer from the financial institution.

31. The method of claim 29, wherein the step of requesting authentication of the identification of the payer includes requesting authentication of the identification of the payer from an identity service provider; and wherein the step of receiving authentication of the identification of the payer includes receiving authentication of the identification of the payer from the identity service provider.

32. The method of claim 29, including the further step of sending the transaction message through the identity service provider to a financial institution where the payer has an account.
